(19) United States
(12) Patent Application Publication
(10) Pub. No.: US 2023/0392397 A1
(43) Pub. Date: Dec. 7, 2023

(54) BUILDING METHODS FOR USE IN AUTOMATED CONSTRUCTION

(71) Applicant: FASTBRICK IP PTY LTD, High Wycombe (AU)

(72) Inventors: Michael John Pivac, High Wycombe (AU); Daniel McKrill, High Wycombe (AU); Harald Apfelthaler, High Wycombe (AU); Maarten Frank Kornaat, High Wycombe (AU)

(21) Appl. No.: 18/249,836

(22) PCT Filed: Oct. 21, 2021
(86) PCT No.: PCT/AU2021/051226

§ 371 Date: Apr. 20, 2023

(30) Foreign Application Priority Data
Oct. 23, 2020 (AU) 2020903855

(51) Int. Cl. E04G 21/22; E04B 2/26; E04B 2/24

(52) U.S. Cl. CPC E04G 21/22; E04B 2/26; E04B 2/24

(57) ABSTRACT

The present disclosure relates to building methods for use in automated construction including a method for use in construction of a building, the method including: (a) laying a plurality of courses of blocks onto a foundation to define: i) walls of a first storey of the building; and, ii) a plurality of hollow formwork columns; (b) inserting reinforcing structure into the hollow formwork columns; and (c) pouring concrete into the hollow formwork columns around the reinforcing structure so as to form concrete columns for supporting a slab of a second storey, wherein the blocks forming the plurality of hollow formwork columns remain part of the building structure as permanent formwork.

### PRIORITY DOCUMENTS

The present application claims priority from Australian Provisional Application No. 2020903855 titled “BUILDING METHODS FOR USE IN AUTOMATED CONSTRUCTION” and filed on 23 Oct. 2020, the content of which is hereby incorporated by reference in its entirety.

### BACKGROUND OF THE INVENTION

The present invention relates to methods for constructing a building at a site using a robotic block laying machine. In a particular example, the methods provide build strategies suitable for use in automated construction.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

It is known to provide systems in which a robot arm mounted on a moving robot base is used to perform interactions within a physical environment. For example, WO 2007/076581 describes an automated brick laying system for constructing a building from a plurality of bricks comprising a robot having an articulating, telescopic and foldable boom provided with a brick laying and adhesive applying head, a measuring system, and a controller that provides control data to the robot to lay the bricks at predetermined locations. The measuring system measures in real time the position of the head and produces position data for the controller. The controller produces control data on the basis of a comparison between the position data and a predetermined or pre-programmed position of the head to lay a brick at a predetermined position for the building under construction. The controller can control the robot to construct the building in a course by course manner where the bricks are placed sequentially at their respective predetermined positions and where a complete course of bricks for the entire building is placed prior to laying of the brick for the next course.

The applicant's Hadrian X® bricklaying robot is an example of the above described automated bricklaying robot incorporated in a truck. The Hadrian X has a 24-32 m long boom that slews, folds and telescopically extends around the building site so as to place blocks in accordance with a datafile controlling operation of the machine. At the end of the boom is a block laying head having an end effector that precisely places each block. A metrology system such as a laser tracker system measures the 6 DOF pose of the end of the boom in real time so that the controller can determine where the end effector of the robot is and if necessary, compensate for movement away from a programmed position to place a block.

Automated construction using robots such as the Hadrian X® is an emerging field that will drive change in conventional methods of construction and design of structures.

### SUMMARY OF THE PRESENT INVENTION

In one broad form, an aspect of the present invention seeks to provide a method for use in construction of a building, the method including:
a) laying a plurality of courses of blocks onto a foundation to define:
   i) walls of a first storey of the building; and,
   ii) a plurality of hollow formwork columns;
b) inserting reinforcing structure into the hollow formwork columns; and
c) pouring concrete into the hollow formwork columns around the reinforcing structure so as to form concrete columns for supporting a slab of a second storey, wherein the blocks forming the plurality of hollow formwork columns remain part of the building structure as permanent formwork.

In one embodiment, for each hollow formwork column, at least one block in a first course thereof is left out of the column to provide an opening to allow access at a base of the column for securing the reinforcing structure.

In one embodiment, the reinforcing structure is one of:
a) coupled to starter bars protruding from the foundation; and,
b) anchored into holes drilled into the foundation and adhesively bonded therein.

In one embodiment, for each hollow formwork column, any open perp gaps are sealed prior to pouring the concrete.

In one embodiment, for each hollow formwork column, the opening at the base of the column is closed prior to pouring of the concrete.

In one embodiment, at least some of the walls of at least the first storey of the building are reinforced.

In one embodiment, reinforcing a wall of the building includes the steps of:
a) laying a first plurality of block courses onto the foundation or slab, at least the first block course placed over starter bars that protrude from the foundation;
b) inserting a first section of reinforcing structure through aligned cavities of the first plurality of courses and coupling a base of the first section of reinforcing structure to the starter bars; and,
c) pouring concrete into the aligned cavities of the first plurality of courses.

In one embodiment, reinforcing a wall of the building further includes the steps of:
a) laying a second plurality of courses on top of the first plurality of courses;
b) inserting a second section of reinforcing structure through aligned cavities of the second plurality of courses and coupling a base of the second section of reinforcing structure to the top of the first section of reinforcing structure; and,
c) pouring concrete into the aligned cavities of the second plurality of courses.

In one embodiment, further sections of reinforcing structure are coupled together as a height of the wall increases.

In one embodiment, each section of reinforcing structure is approximately as long as a height of three courses of blocks.

In one embodiment, the second storey slab is precast and positioned onto the first storey using a crane.

In one embodiment, the building is constructed using a robotic block laying machine that lays blocks in accordance with a block sequence defined by a machine datafile that permits blocks of either the first or second storey to be placed in either a course by course or multiple course sequence.

In one embodiment, the method further includes laying a plurality of courses of blocks onto the second storey slab to define walls of the second storey of the building, wherein multiple courses are constructed simultaneously in accordance with the block sequence specified by the machine datafile.

In one embodiment, a tracking system is used to determine at least the position and optionally orientation of an end effector of the robotic block laying machine, the tracking system requiring line of sight between one or more tracking instruments and one or more tracking targets and wherein the block sequence for the walls of the second storey is determined at least in part using line of sight constraints associated with each block.

In one embodiment, the one or more tracking instruments are positioned adjacent the foundation and the one or more tracking targets are disposed on the machine proximate the end effector and wherein the one or more tracking instruments are positioned higher than the second storey slab.

In one embodiment, the block sequence is determined in at least one electronic processing device by:
a) obtaining build data indicative of block position and size;
b) determining dependency rules associated with each block in the build that define a specific ordering dependency for the blocks such that the line of sight constraints are satisfied; and,
c) generating the block sequence based at least in part on the dependency rules.

In one embodiment, for each block, the method includes in the at least one electronic processing device:
a) determining a subgroup of blocks that have line of sight occluded by a current block;
b) assigning a dependency to the subgroup of blocks specifying that they must each be placed prior to the current block.

In one embodiment, determining the subgroup of blocks includes:
a) determining a first subgroup of candidate blocks that may be occluded in the X axis plane of the tracking instrument;
b) determining a second subgroup of candidate blocks that may be occluded in the Y axis plane of the tracking instrument;
c) optionally determining a third subgroup of candidate blocks that may be occluded in the Z axis plane of the tracking instrument; and,
d) selecting blocks common to the first, second and optionally third subgroup.

In one embodiment, the block sequence is generated by one of:
a) processing all of the blocks in the build in one batch; and,
b) processing groups of blocks iteratively in multiple batches based on number of block dependencies.

In one embodiment, for multiple batch processing, each group of processed blocks has assigned zero dependencies.

In one embodiment, after each batch has been processed, block dependencies of remaining blocks are updated.

In one embodiment, segments of walls further away from the tracking instrument are constructed at least partially in advance of segments of walls closest to the tracking instrument.

In one embodiment, the structure is built up from a distal portion towards a proximal portion relative to the tracking instrument and/or robotic block laying machine.

In another broad form, an aspect of the present invention seeks to provide a method of constructing a building at a site using a robotic block laying machine, the method including constructing walls with the machine by placing blocks in a plurality of courses according to a build strategy, wherein the build strategy includes constructing multiple courses simultaneously or constructing wall substructures sequentially in accordance with a block sequence based at least in part on build constraints associated with at least one of: the site, a building plan, the robotic block laying machine and a tracking instrument used in monitoring a position of the machine and controlling its movement around the site.

In one embodiment, multiple courses are constructed as an arm of the robotic block laying machine retreats back from an extended position towards the machine.

In one embodiment, a single course is constructed as the arm of the robotic block laying machine advances or extends away from the machine.

In one embodiment, segments of walls further away from the tracking instrument and/or robotic block laying machine are constructed at least partially in advance of segments of walls closest to the tracking instrument.

In one embodiment, the structure is built up from a distal portion towards a proximal portion relative to the tracking instrument and/or robotic block laying machine.

In one embodiment, the building is constructed using a substructure retreat, whereby the building plan considers the build as multiple wall substructures which are completed sequentially starting from a substructure furthest away from the machine.

It will be appreciated that the broad forms of the invention and their respective features can be used in conjunction and/or independently, and reference to separate broad forms is not intended to be limiting. Furthermore, it will be appreciated that features of the method can be performed using the system or apparatus and that features of the system or apparatus can be implemented using the method.

### BRIEF DESCRIPTION OF THE DRAWINGS

Various examples and embodiments of the present invention will now be described with reference to the accompanying drawings, in which: —

FIG. 1A is a schematic diagram illustrating a first example of a system for placing blocks during construction;

FIG. 1B is a schematic diagram of a second example of a system for placing blocks during construction;

FIG. 1C is a schematic plan view of the system of FIG. 1B;

FIG. 2 is a schematic diagram of an example of a control system for the systems of FIGS. 1A to 1C;

FIG. 3 is a flowchart of an example of a process for placing blocks during construction;

FIG. 4A is a perspective view of an example of a two-storey building for construction using a robotic block laying machine;

FIG. 4B is a plan view of the first storey layout of the building of FIG. 4A;

FIG. 4C is a side view of the first storey of the building of FIG. 4A;

FIG. 4D is a plan view of the second storey layout of the building of FIG. 4A;

FIG. 5 is a flowchart of an example of a process for use in construction of a building;

FIGS. 6A to 6C provide schematic views of construction of a concrete column using permanent block formwork;

FIG. 7A to 7E provide schematic views of construction of a reinforced block wall;

FIG. 8 is a flowchart of an example of a method for designing a block sequence for use in placing blocks during construction;

FIG. 9A is a schematic plan view of an example of an end effector of a block laying robot holding a block for placement;

FIG. 9B is a schematic end view of an example of an end effector of a block laying robot holding a block for placement;

FIG. 9C is a schematic side view of an example of an end effector of a block laying robot holding a block for placement;

FIG. 10A is a schematic plan view of an example of a block layout for a corner intersection;

FIG. 10B is a schematic plan view of the block layout of FIG. 10A showing the end effector;

FIG. 11 is a schematic side view of an example of a wall block layout;

FIG. 12A is a schematic diagram illustrating line of sight constraints for a tracking instrument when constructing a building;

FIG. 12B is a schematic view in an X-plane illustrating line of sight between a tracking instrument and a target when laying a particular block in the building;

FIG. 12C is a schematic view in a Y-plane illustrating line of sight between a tracking instrument and a target when laying a particular block in the building;

FIG. 12D is a schematic view in a Z-plane illustrating line of sight between a tracking instrument and a target when laying a particular block in the building;

FIG. 13 is a flowchart of a second example of a method for designing a block sequence for use in placing blocks during construction;

FIG. 14 is a flowchart of a second example of a method for designing a block sequence for use in placing blocks during construction; and,

FIGS. 15A to 15F illustrate a series of perspective views of a simulated build sequence of the second storey of the building of FIG. 4A.

### DETAILED DESCRIPTION OF THE PREFERRED EMBODIMENTS

The present disclosure provides methods for use in constructing a building, and in some examples a multi-storey building. In a preferred form, the methods relate to constructing a building using a robotic block laying machine.

For the purpose of illustration, the following definitions apply to terminology used throughout.

A “block” is a piece of material, typically in the form of a polyhedron, such as a cuboid having six quadrilateral and more typically substantially rectangular faces. The block is typically made of a hard material and may include openings or recesses, such as cavities or the like. The block is configured to be used in constructing a structure, such as a building or the like and specific example blocks include bricks, besser blocks, or similar. A “course” of blocks is a row of blocks typically provided at a common vertical height.

The term “interaction” is intended to refer to any physical interaction that occurs within, and including with or on, an environment. Example interactions could include placing material or objects within the environment, removing material or objects from the environment, moving material or objects within the environment, modifying, manipulating, or otherwise engaging with material or objects within the environment, modifying, manipulating, or otherwise engaging with the environment, or the like. Further examples of interactions will become apparent from the following description, and it will be appreciated that the techniques could be extended to a wide range of different interactions, and specified examples are not intended to be limiting. Furthermore, in some examples, interactions may comprise one or more distinct steps. For example, when block laying, an interaction could include the steps of retrieving a block from a block supply mechanism and then placing the brick in the environment.

The term “environment” is used to refer to any location, region, area or volume within which, or on which, interactions, such as block laying, are performed. The type and nature of the environment will vary depending on the preferred implementation and the environment could be a discrete physical environment, and/or could be a logical physical environment, delineated from surroundings solely by virtue of this being a volume within which interactions occur. Non-limiting examples of environments include building or construction sites, and in particular, building slabs, parts of vehicles, such as decks of ships or loading trays of lorries, factories, loading sites, ground work areas, or the like, and further examples will be described in more detail below.

A robot arm is a programmable mechanical manipulator. In this specification a robot arm includes multi axis jointed arms, parallel kinematic robots (such as Stewart Platform, Delta robots), spherical geometry robots, Cartesian robots (orthogonal axis robots with linear motion) etc.

A boom is an elongate support structure such as a slewing boom, with or without stick or dipper, with or without telescopic elements, telescoping booms, telescoping articulated booms. Examples include crane booms, earthmover booms, truck crane booms, all with or without cable supported or cable braced elements. A boom may also include an overhead gantry structure, or cantilevered gantry, or a controlled tensile truss (the boom may not be a boom but a multi cable supported parallel kinematics crane (see PAR systems, Tensile Truss-Chernobyl Crane)), or other moveable arm that may translate position in space.

An end effector is a device at the end of a robotic arm designed to interact with the environment. An end effector may include a gripper, nozzle, sand blaster, spray gun, wrench, magnet, welding torch, cutting torch, saw, milling cutter, router cutter, hydraulic shears, laser, riveting tool, or the like, and reference to these examples is not intended to be limiting. For the purposes of a block laying robot for use in automated building construction, the end effector is typically a gripper which may have clamps or jaws to grip a block or other suitable means of attachment including for instance suction pads.

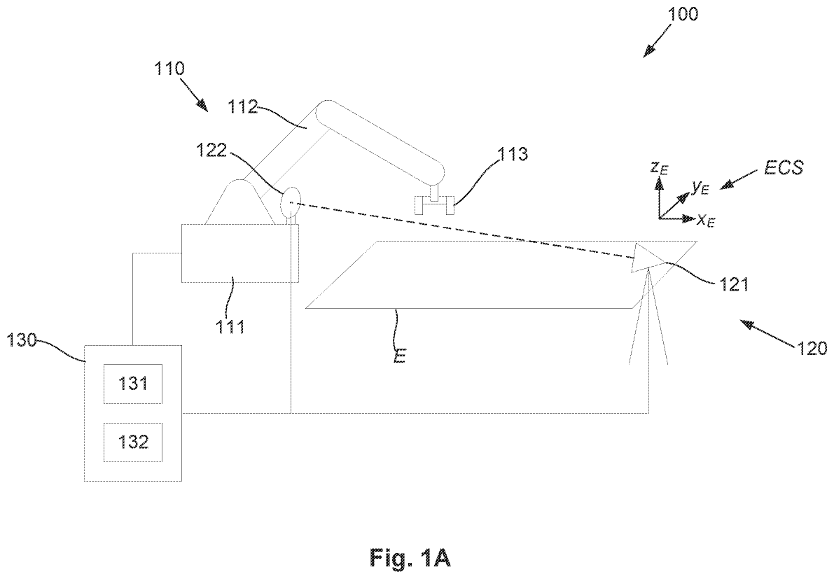

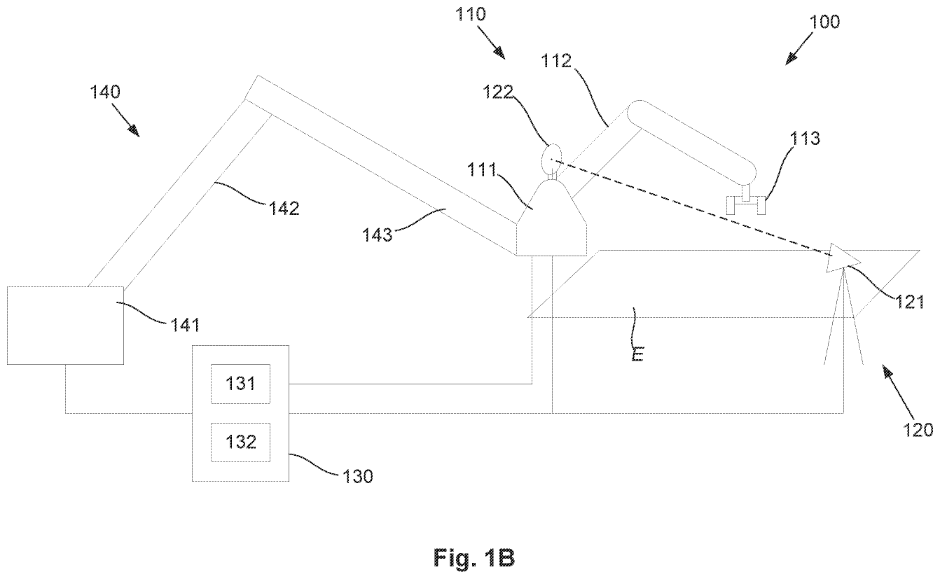

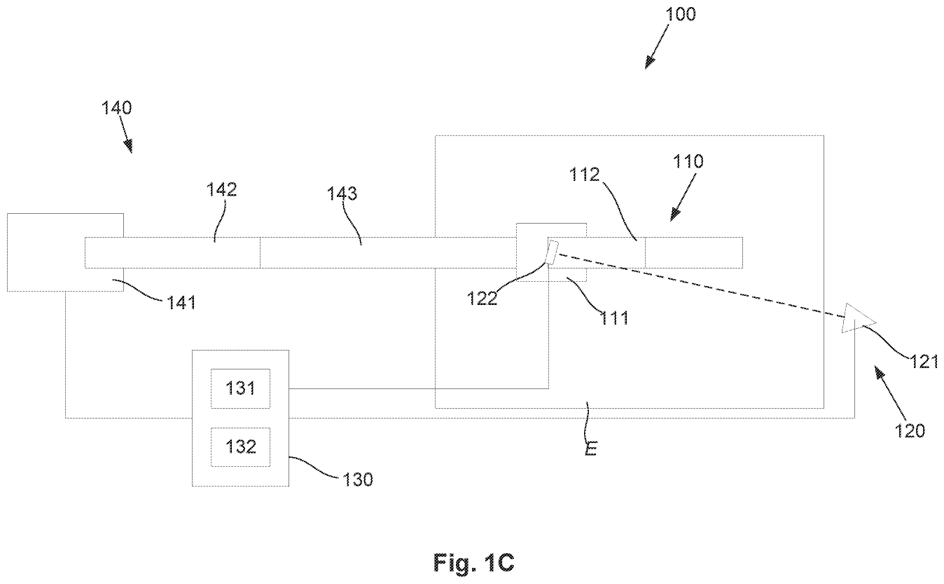

Examples of systems for performing interactions within physical environments, and in particular, positioning blocks on a foundation or slab or other similar arrangement for the purpose of constructing a building, will now be described with reference to FIGS. 1A to 1C and FIG. 2.

In the example of FIG. 1A, the system 100 includes a robot assembly 110 including a head, which in this example, includes a robot base 111, a robot arm 112 and an end effector 113. The robot assembly 110 is positioned relative to an environment E, which in this example is illustrated as a 2D plane, such as a construction slab, but in practice could be a 3D volume of any configuration, for example encompassing positioning blocks on top of a course of blocks, which is in turn positioned on a slab. In use, the end effector 113 is used to perform interactions within the environment E, for example to perform block laying, object manipulation, or the like.

The system 100 also includes a tracking system 120, which is able to track the robot assembly movement, and in one particular example, movement of the robot base 111 relative to the environment. In one example, the tracking system includes a tracker base 121, which is typically statically positioned relative to, and typically offset from the environment E, and a tracker target 122, mounted on the robot base 111, allowing a position of the robot base 111 relative to the environment E to be determined.

In one example, the tracking system 120 includes a tracking base 121 including a tracker head having a radiation source arranged to send a radiation beam to the target 122 and a base sensor that senses reflected radiation. A base tracking system is provided which tracks a position of the target 122 and controls an orientation of the tracker head to follow the target 122. In one example, the target 122 includes a target sensor that senses the radiation beam and a target tracking system that tracks a position of the tracking base and controls an orientation of the target to follow the tracker head. In other examples, the target 122 is a passive instrument that does follow the tracker head. Angle sensors are provided in the tracker head that determine an orientation of the head (e.g. in elevation and azimuth). Optionally, angle sensors are also provided in the target that determine an orientation of the target. A processing system determines a position of the target relative to the tracker base in accordance with signals from the sensors, specifically using signals from the angle sensors to determine relative angles between the tracker and target, whilst time of flight of the radiation beam can be used to determine a physical separation, thereby allowing a position of the target relative to the tracking base to be determined. In a further example, the radiation can be polarised in order to allow a roll angle of the target relative to the tracking base to be determined.

Although a single tracking system 120 including a tracker head and target is shown, this is not essential and in other examples multiple tracking systems and/or targets can be provided as will be described in more detail below. In some examples, the tracking system may include tracker heads positioned on the robot base configured to track one or more targets located in the environment.

In one particular example, the tracking system is a laser tracking system and example arrangements are manufactured by API (Radian and OT2 optionally with STS (Smart Track Sensor)), Leica (AT960 and Tmac) and Faro. These systems measure position at 300 Hz, or 1 kHz or 2 kHz (depending on the equipment) and rely on a combination of sensing arrangements, including laser tracking, vision systems using 2D cameras, accelerometer data such as from a tilt sensor or INS (Inertial navigation System) and can be used to make accurate measurements of position, with data obtained from the laser tracker and optionally the target equating to position and optionally orientation of the target relative to the environment E. The target may be any suitable optical target including for instance a spherically mounted retroreflector (SMR) or the like. As such systems are known and are commercially available, these will not be described in any further detail.

It will also be appreciated that other position/movement sensors, such as an inertial measurement unit (IMU) can also be incorporated into the system.

In practice, in the above described examples, the robot base 111 undergoes movement relative to the environment E. The nature of the movement will vary depending upon the preferred implementation. For example, the robot base 111 could be mounted on tracks, wheels or similar, allowing this to be moved within the environment E.

Alternatively, in the example shown in FIG. 1B, the robot base 111 is supported by a robot base actuator 140, which can be used to move the robot base. In this example, the robot base actuator is in the form of a boom assembly including a boom base 141, boom 142 and stick 143. The boom is typically controllable allowing a position and/or orientation of the robot base to be adjusted. The types of movement available will vary depending on the preferred implementation. For example, the boom base 141 could be mounted on a vehicle allowing this to be positioned and optionally rotated to a desired position and orientation. The boom and stick 142, 143 can be telescopic arrangements, including a number of telescoping boom or stick members, allowing a length of the boom or stick to be adjusted. Additionally, angles between the boom base 141 and boom 142, and boom 142 and stick 143, can be controlled, for example using hydraulic actuators, allowing the robot base 111 to be provided in a desired position relative to the environment E.

An example of a system of this form for laying blocks, such as bricks, is described in WO2018/009981 the content of which is incorporated herein by cross reference. It will be appreciated however that such arrangements are not limited to block laying, but could also be utilised for other forms of interactions.

In the systems shown in FIGS. 1A and 1B, a control system 130 is provided in communication with the tracking system 120 and the robot assembly 110 allowing the robot assembly to be controlled based on signals received from the tracking system. The control system typically includes one or more control processors 131 and one or more memories 132. For ease of illustration, the remaining description will make reference to a processing device and a memory, but it will be appreciated that multiple processing devices and/or memories could be used, with reference to the singular encompassing the plural arrangements and vice versa. In use the memory stores control instructions, typically in the form of applications software, or firmware, which is executed by the processor 131 allowing signals from the tracking system 120 and robot assembly 110 to be interpreted and used to control the robot assembly 110 to allow interactions to be performed.

An example of the control system 130 is shown in more detail in FIG. 2.

In this example the control system 230 is coupled to a robot arm controller 210, a tracking system controller 220 and a boom controller 240. This is typically performed via a suitable communications network, including wired or wireless networks, and more typically an Ethernet or Ethercat network. The robot arm controller 210 is coupled to a robot arm actuator 211 and end effector actuator 212, which are able to control positioning of the robot arm 112 and end effector 113, respectively. The tracking system controller 220 is coupled to the tracking head 221 and target 222, allowing the tracking system to be controlled and relative positions of the tracking head 221 and target 222 to be ascertained and returned to the control system 230. The boom controller 240 is typically coupled to boom actuators 241, 242 which can be used to position the boom and hence robot base. A second tracking system 225 may also be provided, which includes sensors 226, such as inertial sensors, optionally coupled to a controller or processor. It is to be understood that in practice the robot arm, end effector and boom will have multiple actuators such as servo motors, hydraulic cylinders and the like to effect movement of their respective axes (i.e. joints) and reference to single actuators is not intended to be limiting.

In this example, the control system 230 is also coupled to an optional sensing system 270, including one or more sensors 271, which could be configured to sense additional markers, or other aspects of machine operation.

Each of the robot arm controller 210, tracking system controller 220, second tracking system 225, boom controller 240 and sensing system 270 typically include electronic processing devices, operating in conjunction with stored instructions, and which operate to interpret commands provided by the control system 230 and generate control signals for the respective actuators and/or the tracking system and/or receive signals from sensors and provide relevant data to the control system 230. The electronic processing devices could include any electronic processing device such as a microprocessor, microchip processor, logic gate configuration, firmware optionally associated with implementing logic such as an FPGA (Field Programmable Gate Array), or any other electronic device, system or arrangement. It will be appreciated that the robot arm controller 210, tracking system controller 220 and boom controller 240 typically form part of the boom assembly, robot assembly and tracking system, respectively. As the operation of such systems would be understood in the art, these will not be described in further detail.

The control system 230 typically includes an electronic processing device 231, a memory 232, input/output device 233 and interface 234, which can be utilised to connect the control system 230 to the robot arm controller 210, tracking system controller 220 and boom controller 240. Although a single external interface is shown, this is for the purpose of example only, and in practice multiple interfaces using various methods (e.g. Ethernet, serial, USB, wireless or the like) may be provided.

In use, the processing device 231 executes instructions in the form of applications software stored in the memory 232 to allow the required processes to be performed. The applications software may include one or more software modules, and may be executed in a suitable execution environment, such as an operating system environment, or the like.

Accordingly, it will be appreciated that the control system 230 may be formed from any suitable processing system, such as a suitably programmed PC, computer server, or the like. In one particular example, the control system 230 is a standard processing system such as an Intel Architecture based processing system, which executes software applications stored on non-volatile (e.g., hard disk) storage, although this is not essential. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

It will also be appreciated that the above described arrangements are for the purpose of illustration only and practice a wide range of different systems and associated control configurations could be utilised. For example, it will be appreciated that the distribution of processing between the controllers and/or control system could vary depending on the preferred implementation.

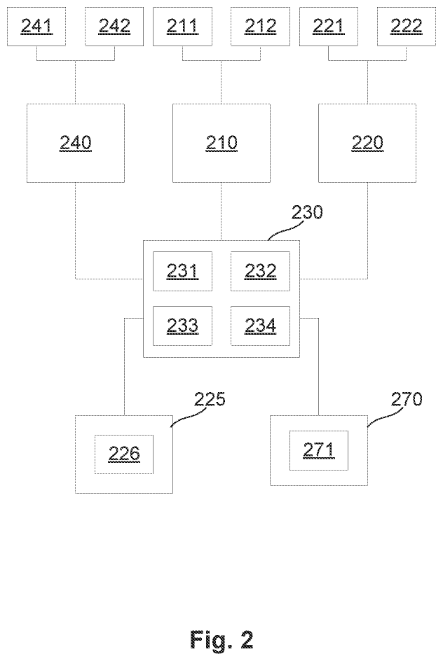

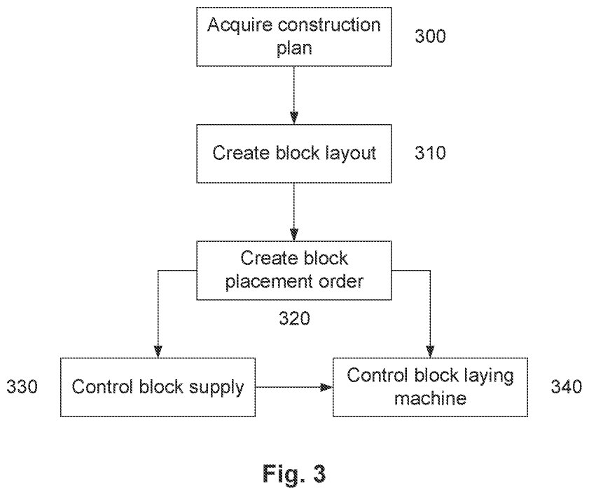

An overview of an example process for placing blocks in an environment E will now be described with reference to FIG. 3.

For the purpose of illustration, it is assumed that the process is performed at least in part using one or more electronic processing devices forming part of one or more processing systems, such as computer systems, servers, or the like, which are optionally connected to other processing systems and one or more client devices, such as mobile phones, portable computers, tablets, or the like, via a network architecture, as will be described in more detail below. For ease of illustration the remaining description will refer to a processing device, but it will be appreciated that multiple processing devices could be used, with processing distributed between the devices as needed, and that reference to the singular encompasses the plural arrangement and vice versa.

In one particular example, the processing device is part of a processing system such as an Intel Architecture based processing system, which executes software applications stored on non-volatile (e.g., hard disk) storage, although this is not essential. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

For the purpose of illustration, it will be assumed that the blocks are placed using a block laying machine or robot similar to that described above with respect to FIGS. 1A to 1C, and FIG. 2, although it will be appreciated that this is not intended to be limiting, and does not preclude the process being implemented with other block laying arrangements, including but not limited to other designs of brick or block laying machines, or manual brick or block laying techniques.

Whilst the processing device could form part of the control system 230, more typically the processing device is remote to the control system, with block layout data and/or block sequence data being provided to the control system 230 to allow the block laying machine to be controlled as will be apparent from the description below.

In this example, at step 300 the processing device acquires a construction plan, such as a building plan, or similar. The construction plan could be acquired in any suitable manner, and may be determined in accordance with user input commands, provided via a user interface or similar, which define the construction plan. Alternatively, the construction plan could be received from software, such as a Computer Aided Design (CAD) software application, which is used to construct the plan, such as an architectural software package (e.g. Revit, ArchiCAD), or more general CAD package such as SolidWorks, or the like. In a further example, the construction plan could be retrieved from a database or other repository. The construction plan typically specifies details of any walls to be constructed, including a start and end point of the walls, and any other relevant information, such as the types of blocks to be used, a wall width, wall height, or similar as well as position of windows, doors etc.

At step 310, the processing device creates a block layout. The block layout specifies the location in which each block should be placed in order to build the construction. In one example, the block layout is created in order to minimise the number of blocks used, whilst also taking into account other requirements, such as the need to avoid joins between blocks aligning over multiple courses. The block layout is typically created by considering multiple different layouts, and in one example, by using an iterative optimisation process. The block layout is typically specified in terms of a position coordinate (X, Y, Z) and rotation for each block, although it will be appreciated that other suitable arrangements could be used. Methods for generating block layouts are described in applicant's co-pending application PCT/AU2020/050367 which is hereby incorporated by reference.

At step 320, the processing device uses the block layout to create a block sequence (i.e. block placement order). The block sequence specifies the order in which each block should be placed in order to construct the building plan, and in particular the block layout. Thus, assuming a robotic block laying machine is used, the block layout and block sequence collectively define a path that the head of the block laying machine, and in particular the robot base 111 and end effector 113, should traverse in order to place the blocks. In one example, the block sequence is created in order to minimise the distance traversed, whilst also taking into account other requirements, such as dependencies, which represent the need to place particular combinations of blocks in a particular order, for example to avoid overhangs during construction, end effector gripper clashes with previously laid blocks, loss of sight of the tracking instrument(s) or similar. The block sequence is typically created by considering multiple different block sequences, and in one example, by using an iterative optimisation process. The block sequence is typically specified in terms of an ordered list of blocks, with the position of each block being defined in the block layout, although it will be appreciated that other suitable arrangements could be used.

At step 330, the block layout and/or block sequence can be used to control a block supply, for example to ensure the correct amount of blocks are delivered to site to allow construction to be performed. The blocks can be provided in different types, with the required number of each type being supplied. Optionally, the blocks can be supplied in accordance with the sequence, so that blocks are removed from a pallet or other supply in turn, and then placed directly in accordance with the block sequence. This is not essential however, and alternatively the blocks could be provided and ordered as needed.

At step 340, the blocks can be placed, for example by controlling a block laying machine similar to that previously described, thereby allowing the building to be constructed. In this example, the block layout and block sequence can be uploaded to the control system 230 as block layout data and block sequence data respectively. The control system is then able to control the block laying machine in accordance with the block layout and block sequence, for example controlling the boom to position the robot base 111, and controlling the robot arm 112 to position the end effector 113, so that the blocks are placed at the correct location in the correct order, thereby allowing a building or other structure to be constructed.

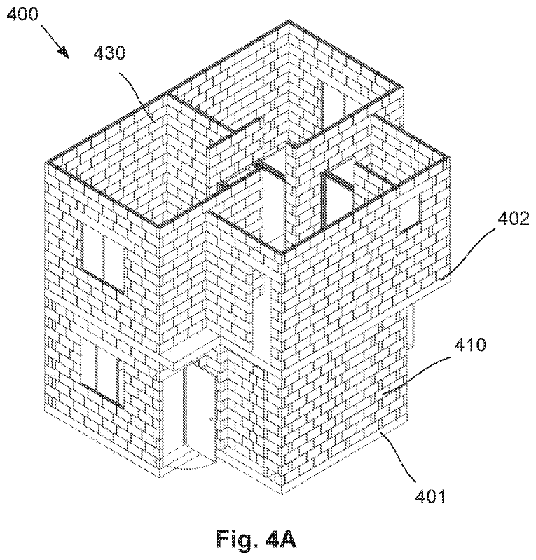

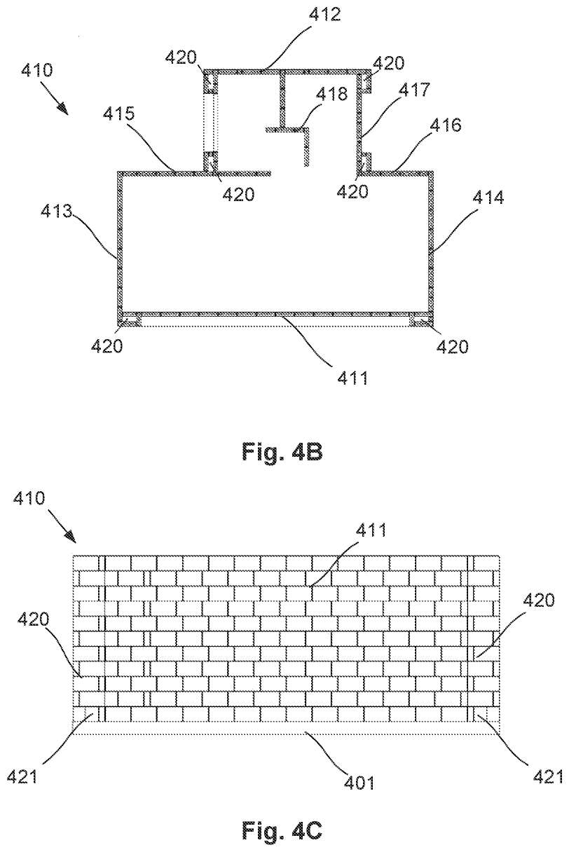

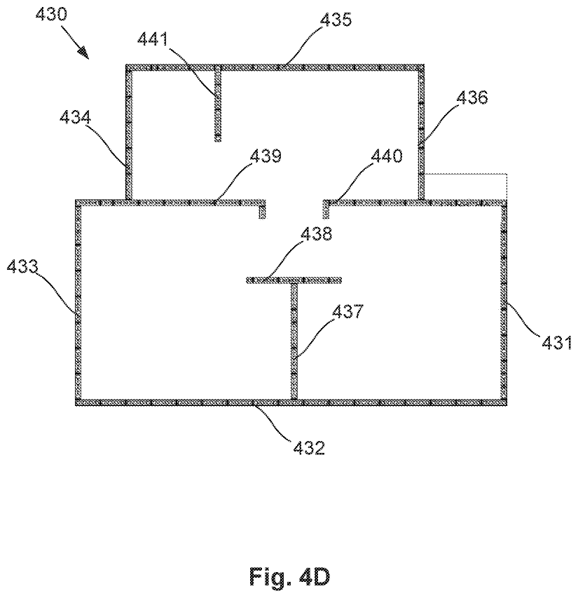

Examples of methods for use in construction of a building using a robotic blocklaying machine will now be described with reference to the building 400 shown in FIG. 4A which is a two-storey building comprising a foundation 401, first storey 410, second storey slab 402 and second storey 430.

The first and second storeys are constructed using bricks or blocks. In one example, the blocks comprise a generally cuboid body having a top and a base; a length extending between a pair of opposed ends; a width extending between a pair of opposed sides; a plurality of hollow cores extending from said top to said base, and arranged in a row between said opposed ends; wherein each core has an identical rectilinear cross-sectional shape; and, wherein a thickness of the block between each pair of adjacent cores is at least double the thickness of the block on all other sides of each core, so that the block is divisible along its length into a plurality of block portions of rectilinear cross-sectional shape, each block portion including four peripheral walls of substantially uniform wall thickness about its one or more cores so that the block or any divisible block portion can be used to construct a wall in accordance with a grid system based on the size of the smallest divisible block portion which enables the cores of each block or divisible block portion in adjacent courses of the wall to be aligned.

FIGS. 4B and 4C depict plan and side views of the first storey 410 of the building 400. In this example, the structure includes a plurality of external and internal walls 411, 412, 413, 414, 415, 416, 417 and 418 and a plurality of columns or pillars 420 for carrying load of the second storey slab and structure when filled with concrete to form concrete columns. In this example, the columns 420 are formed by blocks that are placed so as to form columns with a rectangular cavity Tillable with concrete. The block columns therefore function as formwork and it will be appreciated that the formwork is erected simultaneously with the remainder of the block walls of the building. This method of creating block formwork columns whilst concurrently building up the walls of the structure is well suited to robotic block laying machines.

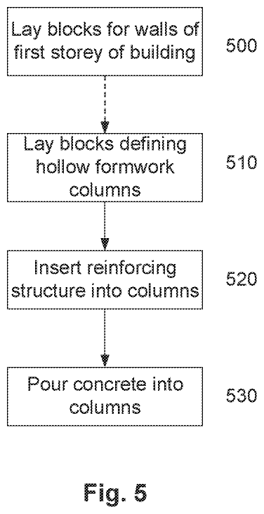

Accordingly, there is provided a method for use in construction of a building as will now be described with reference to FIG. 5. In this example, the method includes laying a plurality of courses of blocks onto a foundation to define walls of a first storey of the building at step 500; and, a plurality of hollow formwork columns at step 510. Whilst the walls and columns could be erected in sequence, more typically the structure is designed so that the columns are integrated as part of the wall design and hence constructed concurrently. In this regard, the structure including walls and columns may be built course by course, or alternatively in a multiple course manner whereby more than one course is being constructed simultaneously.

At step 520, the method includes inserting reinforcing structure into the hollow formwork columns. Any suitable reinforcement structure such as reinforcing bars, cages and mesh may be inserted depending on the application. Finally, at step 530, the method includes pouring concrete into the hollow formwork columns around the reinforcing structure so as to form concrete columns for supporting a slab of a second storey, wherein the blocks forming the plurality of hollow formwork columns remain part of the building structure as permanent formwork.

The above method is particularly useful when constructing buildings in seismic areas to be earthquake resistant. In the above example, a robotic blocklaying machine can be used to build the structure whereby the block formwork for the concrete columns is also built by the robot and then subsequently left in place as permanent formwork. This is advantageous as it minimises labour costs associated with erecting more traditional formwork to pour concrete columns, increases building efficiency and enhances the overall aesthetic appearance of the finished structure.

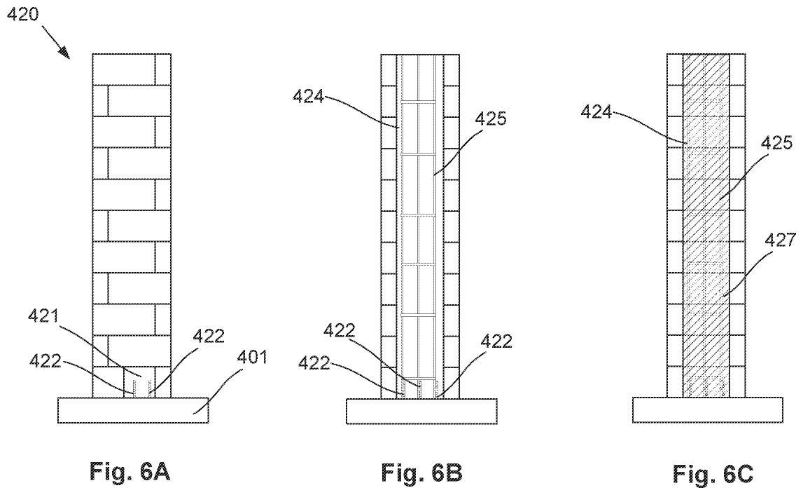

In one example, for each hollow formwork column 420, at least one block in a first course thereof is left out of the column to provide an opening 421 to allow access at a base of the column for securing the reinforcing structure. This is illustrated in FIG. 6A, in which the opening 421 provides a tradesman access to a plurality of starter bars 422 that protrude out of the foundation 401 inside of the column.

Typically, the reinforcing structure is coupled to the starter bars protruding from the foundation as shown for example in FIG. 6B. In this example, a reinforcing cage 425 is dropped inside the internal cavity 424 of the column and a tradesman would then secure it to the starter bars using a tie or wire or any other suitable means of connection known in the art.

Alternatively, in instances where there is no starter bar installed, holes may be drilled into the foundation and the reinforcing structure may be anchored into the holes and bonded therein using a suitable construction adhesive.

After the reinforcing structure has been inserted, the concrete 427 is poured into the internal cavity 424 around the reinforcing structure so as to form the concrete columns. Prior to pouring the concrete any open perp gaps between blocks in the hollow formwork column are filled with a sealant and the opening at the base of the column is closed prior to pouring of the concrete. For example, a block may be inserted into the opening 421 or it may be covered up with a wooden board or similar.

In addition to reinforcing the columns, at least some of the walls of at least the first storey 410 of the building 400 are reinforced as well.

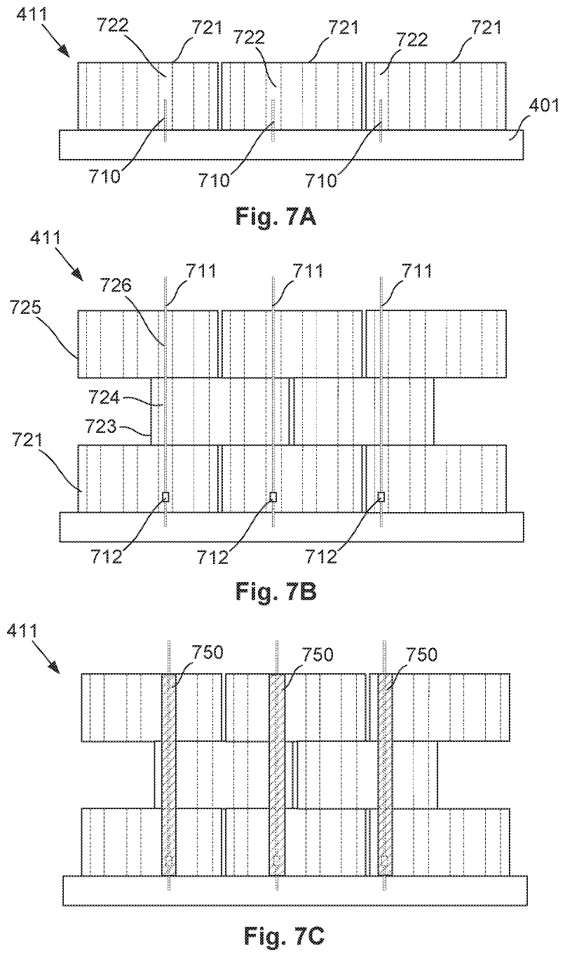

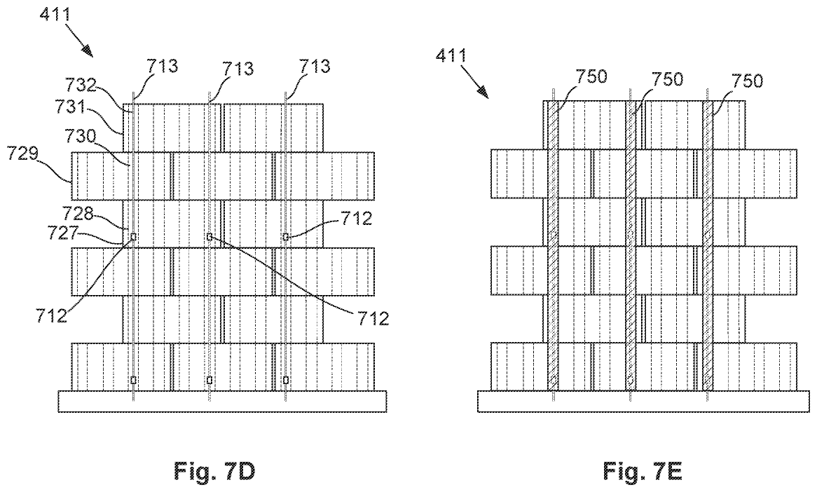

FIGS. 7A to 7E illustrate a method of reinforcing a block wall 411 that has been constructed so that cavities of blocks in the wall are aligned from top to the bottom of the wall.

The first step of the method is to lay a first plurality of block courses onto the foundation or slab 401, at least the first block course placed over starter bars 710 that protrude from the foundation. This is depicted in FIG. 7A in which blocks 721 of the first course are placed so that that starter bars 710 protrude into block cavities 722. As shown in FIG. 7B, the method then includes inserting a first section of reinforcing structure 711 through aligned cavities 722, 724, 726 of the first plurality of courses (e.g. of block 721 in a first course, block 723 in a second course and block 725 in a third course) and coupling a base of the first section of reinforcing structure 711 to the starter bars 710. A threaded coupling 712 or similar can be used to join the bars together. Once the first section of reinforcing structure has been connected, concrete 750 is poured into the aligned cavities of the first plurality of courses. As shown in FIGS. 7B and 7C, typically the first section of reinforcing structure 711 extends above the top face of the highest block.

As depicted in FIGS. 7D and 7E, the method further includes laying a second plurality of courses on top of the first plurality of courses, inserting a second section of reinforcing structure 713 through aligned cavities 728, 730, 732 of the second plurality of courses (e.g. of block 727 in a fourth course, block 729 in a fifth course and block 731 in a sixth course) and coupling a base of the second section of reinforcing structure 713 to the top of the first section of reinforcing structure 711; and pouring concrete into the aligned cavities of the second plurality of courses. This process repeats as many times as needed with further sections of reinforcing structure coupled together as a height of the wall increases. In the above example, each section of reinforcing structure is approximately as long as a height of three courses of blocks, however this may of course be varied and shorter or longer sections of reinforcing structure such as steel reinforcing bar may be used.

Once the concrete in the columns and reinforced block walls has cured, the second storey slab 402 may be constructed in-situ or positioned onto the first storey using a crane if precast.

Once the second storey slab 402 has been placed onto the columns 420, the second storey structure can be built. The following description relates to construction of the building using a robotic block laying machine that lays blocks in accordance with a block sequence defined by a machine datafile that permits blocks of either the first or second storey to be placed in either a course by course or multiple course sequence.

The method of constructing the building further includes laying a plurality of courses of blocks onto the second storey slab 402 to define walls (e.g. with reference to FIG. 4D as an example walls 431, 432, 433, 434, 435, 436, 437, 438, 439, 440 and 441) of the second storey 430 of the building 400, wherein multiple courses are constructed simultaneously in accordance with the block sequence specified by the machine datafile.

Typically, a tracking system is used to determine at least the position and optionally orientation of an end effector of the robotic block laying machine, the tracking system requiring line of sight between one or more tracking instruments and one or more tracking targets and wherein the block sequence for the walls of the second storey is determined at least in part using line of sight constraints associated with each block.

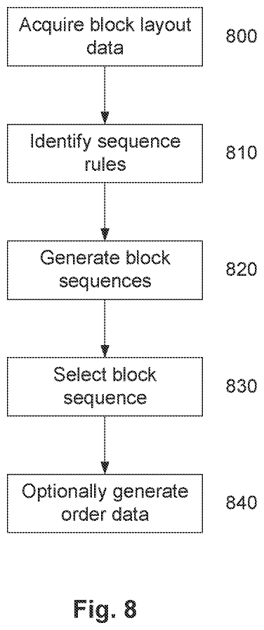

In this regard, an example of a process for designing a block sequence for use in placing blocks during construction will now be described with reference to FIG. 8.

In this example, at step 800, the processing device acquires block layout data indicative of block layouts (e.g. position and size) for a number of block courses. The block layout data can be acquired in a variety of manners, including receiving block layout data from a CAD package or other software application, using user input commands to define the block layout data, retrieving the block layout data from a database, or the like.

At step 810, the processing device identifies one or more sequence rules. The sequence rules are typically previously defined and stored in a database or other repository, allowing these to be retrieved as needed. The sequence rules typically specify limitations on the order in which the blocks can be positioned, known as dependencies, and can be defined based on physical limitations associated with equipment placing the blocks, and/or limitations on viable construction.

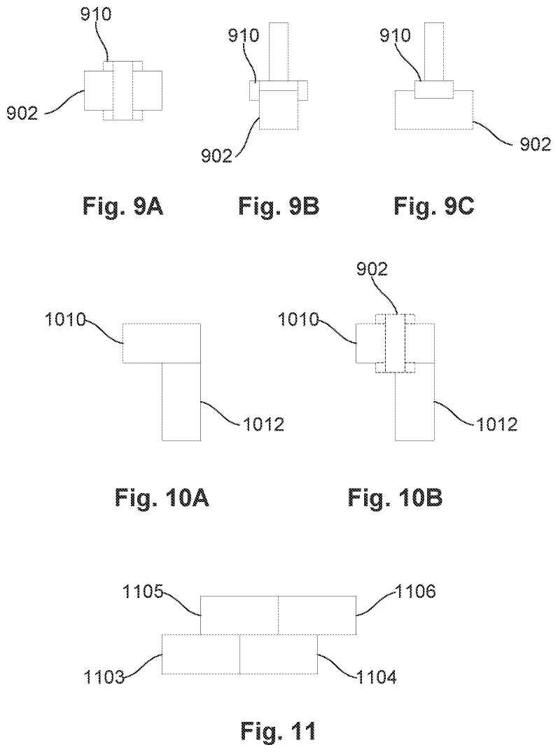

For example, a block laying machine will typically include an end effector configured to grasp the blocks and this can limit how blocks can be placed as will now be described with reference to FIGS. 9A to 9C and 10A and 10B.

In this regard, FIGS. 9A to 9C show how an end effector 910 can be used to grasp a block 902, with the location of the end effector effectively generating an exclusion zone adjacent the end effector. For the corner block layout formed from blocks 1010, 1012 in FIG. 10A, this prevents the block laying machine placing the block 1010 if the block 1012 is already in place. Thus, in this instance a dependency is created requiring that the block 1012 is laid after the block 1010, making the block 1010 a parent block, with the block 1012 being a dependent child block.

Similarly, in the case of the wall shown in FIG. 11, it is not possible to place the block 1105 before the block 1104, and overhangs as shown by block 1106 are therefore precluded. Thus, in this instance, the block 1105 depends on the block 1104.

It will be appreciated that dependencies may also arise for a variety of other reasons. For example, the block laying machine might have limitations on the handling of different sized blocks, which might require that all partial blocks within a course are laid at the same time. In addition to dependencies, other limitations may arise, such as limitations on operation of the machine, starting positions for the build, or the like.

At step 820, the processing device generates different block sequences. Each block sequence specifies an order in which blocks should be placed and is generated at least in part based on the sequence rules, thereby ensuring any dependency requirements are met. The sequences can be generated in any manner, such as selecting a next block based on the block that is closest to the previous block, although it will be appreciated that other suitable arrangements could be used.

This process is repeated so a number of different block sequences are created, with one of these being selected for use at step 830, for example, so as to minimise a distance travelled by a block laying head (i.e. lay head) of the block laying machine. This can then optionally be used to generate sequence or order data, which in one example is in the form of an ordered sequence of blocks, which can be used by a block laying machine in order to construct the building.

As mentioned above, the block sequence for the walls may be determined at least in part using line of sight constraints associated with each block which create further block dependencies for the block sequencing algorithm to process when generating a block sequence.

In one example, the one or more tracking instruments (such as laser tracker(s)) are positioned adjacent the foundation and the one or more tracking targets (e.g. spherically mounted retroreflectors (SMRs)) are disposed on the machine proximate the end effector. In order to place a block at any given position, the laser tracker(s) must have line of sight to the target(s). If a structure interferes with or occludes that line of sight then the machine will not be able to accurately place the block. For the particular building example in FIG. 4, the one or more tracking instruments must be positioned at least higher than the second storey slab, otherwise some blocks of the second storey would not be able to be placed.

Generally, when line of sight constraints are considered, the block sequence is determined in at least one electronic processing device by: obtaining build data indicative of block position and size; determining dependency rules associated with each block in the build that define a specific ordering dependency for the blocks such that the line of sight constraints are satisfied; and, generating the block sequence based at least in part on the dependency rules.

An example method of determining block dependencies to ensure line of sight constraints are satisfied shall now be described. The method includes in the at least one electronic processing device: determining a subgroup of blocks that have line of sight occluded by a current block; and, assigning a dependency to the subgroup of blocks specifying that they must each be placed prior to the current block.

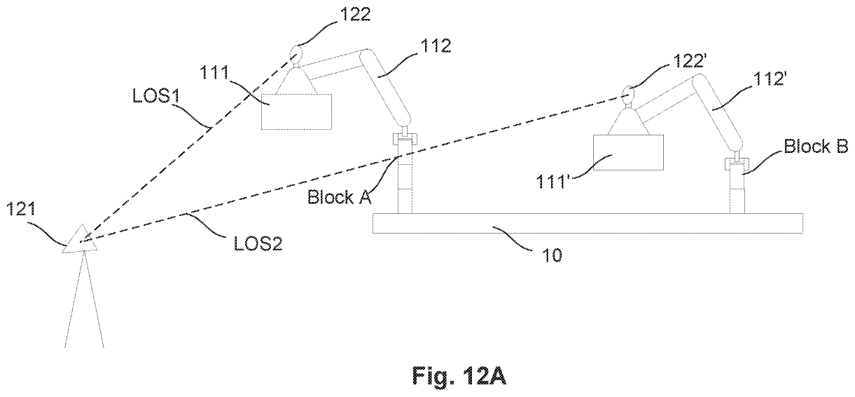

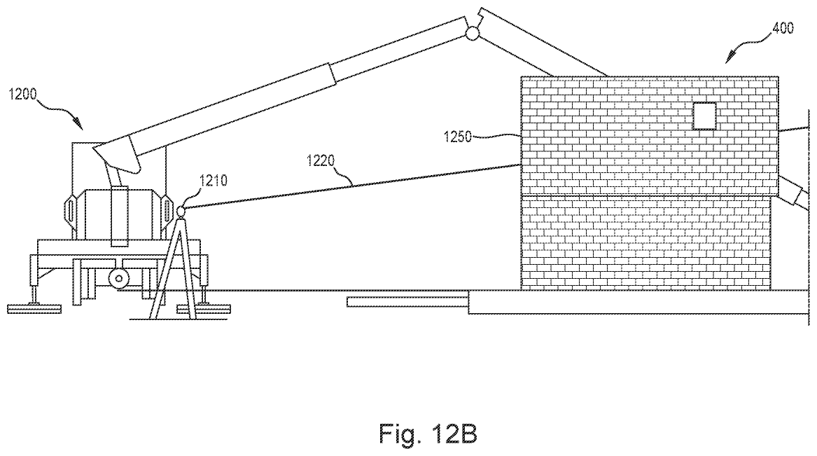

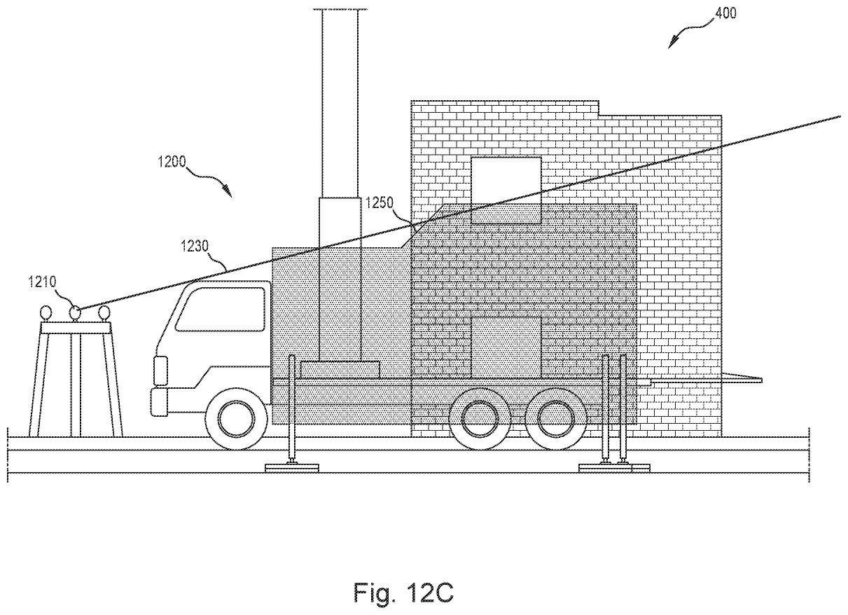

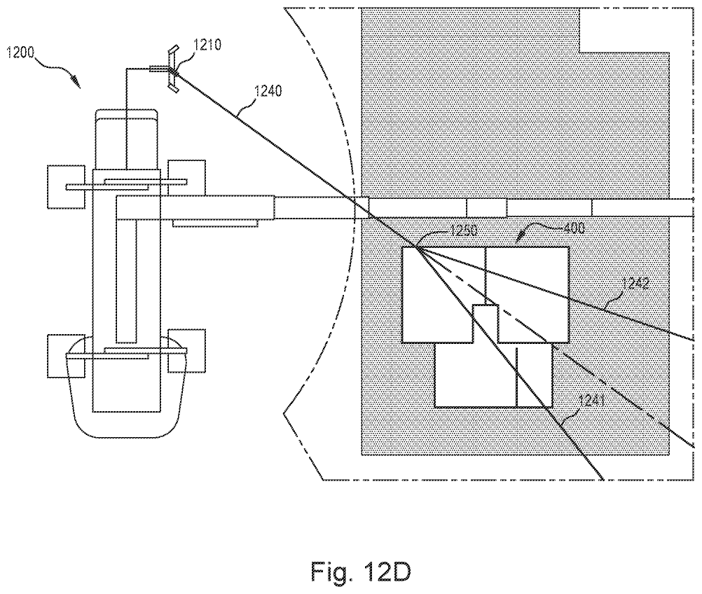

For example, as shown schematically in FIG. 12A, there is shown a tracking instrument such as a laser tracker 121 having line of sight LOS1 to target 122 mounted on a block laying head 111 having a robotic block laying arm 112 positioned to lay block A. Also shown is the position of the robot when laying Block B (depicted by head 111′, robot arm 112′ and target 122′). The tracking instrument 121 requires line of sight LOS2 to target 122′ in order to place Block B. As shown in this example, LOS2 would be occluded by Block A as it would block the laser beam and effectively “shadow” Block B. Block B must therefore be placed before Block A is placed and is therefore a dependency for Block A. In one example, to determine all dependencies for Block A, LOS1 is used to define a plane or slice through the structure along LOS1 and all blocks that fall below that slice are considered to be dependent blocks. This process can be performed in one or more of the X, Y or Z planes as will be described in further detail below with reference to FIGS. 12B, 12C and 12D.

The subgroup of blocks that have line of sight occluded by a current block may be determined in the following manner. Firstly, a first subgroup of candidate blocks that may be occluded in the X axis plane of the tracking instrument is determined. Then a second subgroup of candidate blocks that may be occluded in the Y axis plane of the tracking instrument is determined. Optionally, a third subgroup of candidate blocks that may be occluded in the Z axis plane of the tracking instrument is determined; and, finally blocks common to the first, second and optionally third subgroup are selected and these become the subgroup of occluded blocks for each current block being processed.

The above steps of determining a subgroup of occluded blocks for each current block is illustrated schematically in FIGS. 12B to 12D. In FIG. 12A, there is shown the position of a robotic block laying machine 1200, tracking instrument 1210 and structure under construction 400. This diagram illustrates a line of sight 1220 of a laser beam or similar optical path in an X-axis plane to a target position (not shown in these figures) associated with placing of a block 1250. A slice is taken through the structure along this line and all blocks that fall below this slice form the first subgroup of candidate blocks. The same process is then performed along the Y-axis plane as shown in FIG. 12B and line of sight 1230 is used to create a second slice through the structure such that all blocks that fall below that slice form the second subgroup of candidate blocks. An intersect function may then be performed on the first and second subgroups to determine the blocks in common between both groups. This common subgroup of blocks then become line of sight dependent blocks for block 1250 and must be placed before block 1250 is placed. As only the X and Y planes are considered in this example, this will be a conservative subgroup containing some blocks which actually could be placed after block 1250 is placed.

The subgroup of occluded blocks can be made smaller by further considering the Z-axis plane for example as shown in FIG. 12C. In this example, the line of sight 1240 extends through block 1250, however to account for errors in placement of the tracking instrument as well as unexpected movement of the boom (e.g. due to wind, inertia etc.) the line of sight is considered as divergent lines 1241, 1242 that diverge away from block 1250 about opposing sides of line 1240. Slices of the structure are then taken along lines 1241, 1242 so as to form a wedge containing a third subgroup of occluded blocks for the current block 1250. When this further subgroup is used to find blocks in common with the first and second subgroups, the list of occluded blocks for each current block being processed becomes smaller and converges towards the true list of blocks that actually are most likely to be occluded by the current block.

Once the block occlusion or “shadow” checks have been run, the block sequence may be generated by either processing all of the blocks in the build in one batch; or processing groups of blocks iteratively in multiple batches based on number of block dependencies. In one example, for multiple batch processing, each group of processed blocks has assigned zero dependencies. In other words, only blocks that don't occlude any other block in the build are grouped together and sent to the block sequence processor for ordering. After each batch has been processed, block dependencies of remaining blocks are updated. So for example if Block A originally occluded Block B and Block C, and Block B and C have been sequenced into the build, then Block A has no remaining dependencies and may also now be sent to the block sequence processor. Whilst the sequence is preferably generated in multiple batches, the batches can include blocks with some dependencies, for example, 1, 2, 3, 4, 5 . . . etc. and this may in fact improve the build sequence by generating a more optimal laypath for the machine. All of the blocks with unlimited dependencies could also be sent to the block sequence processor if desired, however this may result in pyramidal style structures within the build that may be undesirable due to risk of machine collision with parts of the structure. Likewise, if the Z-axis check is taken into consideration, the number of blocks with zero dependencies will increase resulting in larger batch sizes being sent to the block processor which may reduce distance travelled by the block laying head, but at the same time result in more pyramidal style structures which may not be desirable.

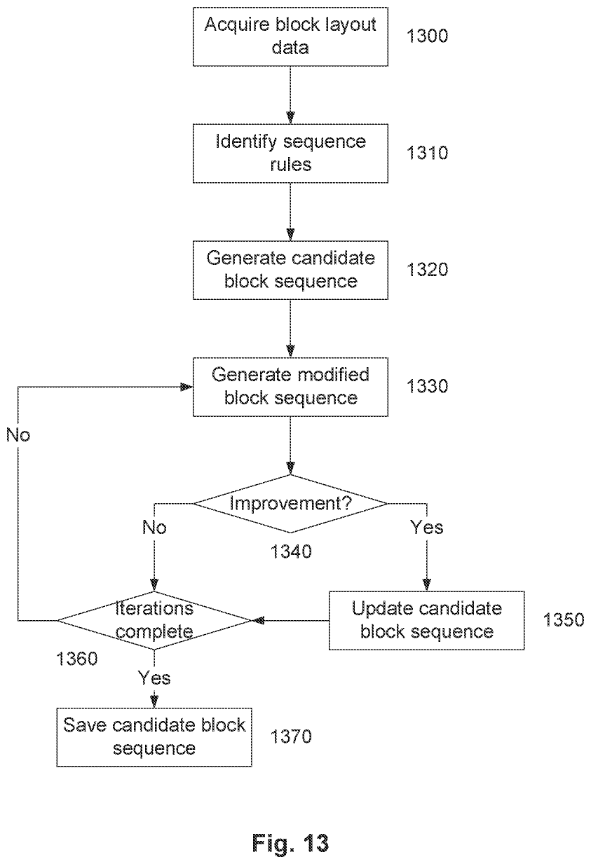

A further example of a method for designing a block sequence for use in block placement during construction will now be described with reference to FIG. 13.

In this example, at step 1300, block layout data is acquired, for example by having performed the layout process described above. At step 1310, the processing device identifies sequence rules, defining restrictions on how blocks can be ordered within the sequence, for example based on dependencies required in order to allow the block laying machine to successfully place blocks (such as to prevent line of sight occlusion between the tracking instrument(s) and target(s) as described above).

At step 1320, the processing device generates a candidate block sequence, typically by selecting a block, identifying the nearest block that satisfies the sequence rules, and then repeating this until all blocks are included in the candidate block sequence.

At step 1330, a modified block sequence is created by selecting adjacent blocks in the sequence that have a greatest physical spacing in the block layout, and then reordering these blocks and generating a new sequence. The processing device compares the modified and candidate block sequence to determine if there is any improvement at step 1340. This will typically involve calculating a cost for each block sequence, based on the cost of individual components such as the distance travelled by the head of the block laying machine, and then comparing the costs, with the lower cost representing the better of the candidate and modified block sequences.

If the modified block sequence represents an improvement, then the current candidate block sequence is replaced with the modified block sequence at step 1350, otherwise the current candidate block sequence is retained.

At step 1360, the processing device determines if the iterations are complete, for example if a required number of iterations have been completed, or the current candidate block sequence is deemed acceptable, and if not, the process returns to step 1330 to generate a new modified block sequence. Otherwise, the candidate block sequence is saved for later use at step 1370, for example in controlling a block laying machine.

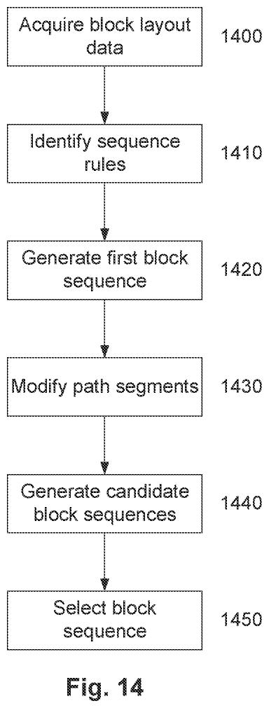

A further example of a method for designing a block sequence for use in block placement during construction will now be described with reference to FIG. 14.

In this example, at step 1400, block layout data is acquired, for example by performing the layout process described above, retrieving a previously generated layout, or the like. At step 1410, the processing device identifies sequence rules. Initially, the sequence rules typically only define restrictions on how blocks can be ordered within the sequence, for example based on dependencies required in order to allow the block laying machine to successfully place blocks (such as to prevent line of sight occlusion between the tracking instrument(s) and target(s) as described above). The sequence rules can be generated based on an understanding of operation of the machine and the requirements associated with wall building, such as ensuring adequate support of higher courses, and may be input manually, generated from the block layout or retrieved as part of the block layout data, depending on the preferred implementation.

At step 1420, the processing device generates a first block sequence, typically by selecting a block, identifying the nearest block that satisfies the sequence rules, and then repeating this until all blocks are included in the first block sequence.

At step 1430, the processing device modifies path segments, typically by identifying the longest path segments, and then altering these so that a shorter path segment length is created. Following this, the processing device recalculates remaining parts of the sequence, for example using a nearest block approach, at step 1440 to thereby generate a second candidate block sequence.

Steps 1430 and 1440 can be repeated a number of times, by modifying different path segments, with this being used to generate multiple second candidate block sequences, which in turn allows the processing device to select the block sequence using one of the second candidate block sequences at step 1450.

Accordingly, it will be appreciated that this provides a further alternative approach to designing a block sequence, which again generates multiple candidate block sequences using sequence rules, and then selects one of the multiple candidate block sequences for use, for example by selecting a block sequence that defines a shortest overall path length.

Further details of specific implementations of the above described methods for designing block sequences are provided in applicant's co-pending application PCT/AU2020/050368 which is hereby incorporated by reference.

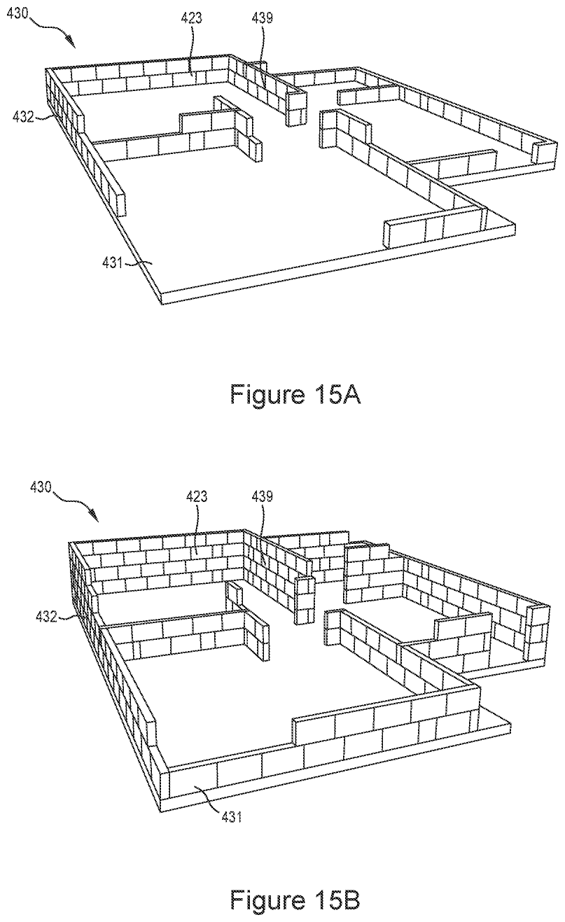

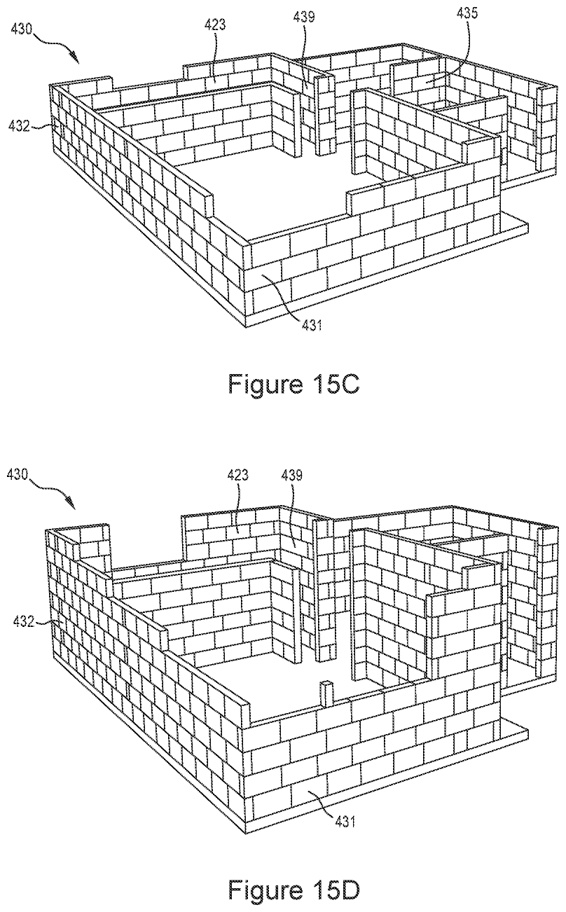

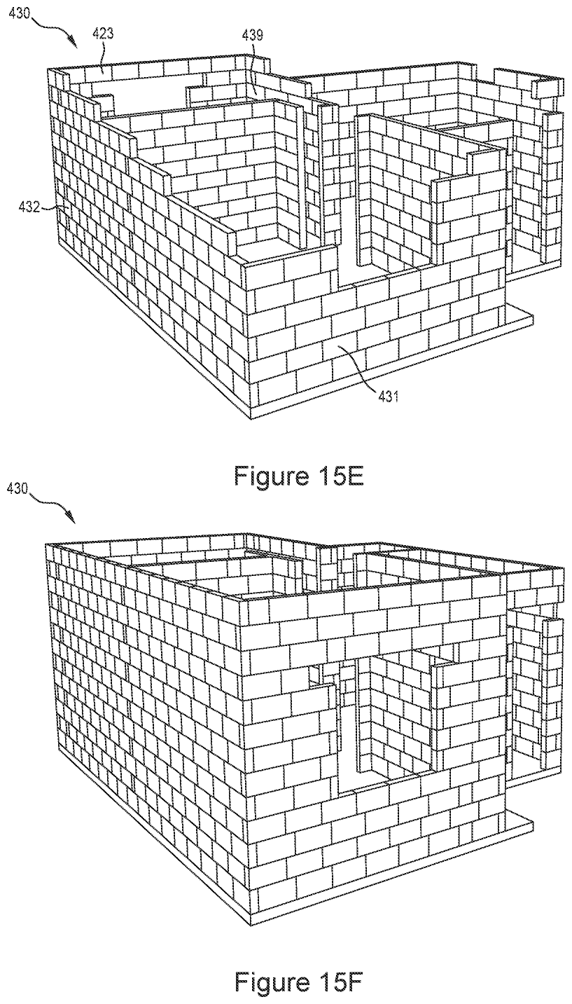

An example of a block sequence simulation of the second storey 430 of building 400 is shown in FIGS. 15A to 15F. In this example, segments of walls (e.g. 423, 432, 435, 439 etc.) further away from the tracking instrument are constructed at least partially in advance of segments of walls (e.g. 431) closest to the tracking instrument (each view in FIGS. 15A to 15F is from an approximate perspective of the tracking instrument). In this regard, parts of the structure are constructed using a multiple course retreat build strategy in which the robot places blocks in multiple courses as its boom and end effector is retreating away from an extended position utilizing reach of the end effector robot as the boom is traversing. A multiple course retreat build strategy is useful for optimizing various constraints and parameters such as line of sight of the position measuring system (particularly when building multi-story constructions, but also applicable for single storey structures) as discussed above or alternatively speed of build, minimization of robot travel path etc. In a retreat build strategy, the structure is built up from a distal portion of the structure to a proximal portion of the structure (both distal and proximal portions relative to the position of the tracking instrument or robotic block laying machine). In other words, portions of the structure further away from the tracking instrument or robotic block laying machine are built up at a faster rate than portions of the structure that are closest to the tracking instrument or robotic block laying machine. As multiple courses are constructed concurrently in this manner, the build strategy is referred to as a multiple course retreat.

The above is an example of a method of constructing a building at a site using a robotic block laying machine, the method including constructing walls with the machine by placing blocks in a plurality of courses according to a build strategy, wherein the build strategy includes constructing multiple courses simultaneously or constructing wall substructures sequentially in accordance with a block sequence based at least in part on build constraints associated with at least one of: the site, a building plan, the robotic block laying machine and a tracking instrument used in monitoring a position of the machine and controlling its movement around the site.

A retreat build strategy could be used in the construction of any building structure, both single storey and multiple storey. For instance, in some examples, it may be desirable to use a tracking instrument such as one or more laser trackers mounted to a tripod or other mounting structure that is relatively short and/or compact to reduce equipment taken to a building site and/or improve useability, handling and time to setup the equipment. In this case, the tracking instruments may be positioned lower than the height of the walls such that their field of view to their respective targets would be ordinarily obstructed by part of the wall structure if laying blocks in a course-by-course manner. In this example, a retreat build strategy would be used whereby wall sections further away from the tracking instrument(s) are constructed at least partly in advance of wall sections closest to the tracking instruments to ensure that line of sight between the tracking instrument(s) and target(s) is always maintained. In some examples, the build strategy may include a substructure retreat whereby the build plan considers the build as multiple substructures which may be completed sequentially starting for instance from a substructure furthest away from the robot. The substructure may be a discrete structure not connected to other parts of the build or alternatively it may be a defined section of the wall structure. In some examples, there may be volumetric constraints associated with existing structures on the build site such as existing walls, fences, adjacent dwellings or other objects that need to be considered when planning the build strategy and which may necessitate a substructure or multiple course retreat in order to avoid potential collisions with the machine.

In a multiple course retreat build strategy, typically the robot arm (i.e. boom) will extend away from the robot (i.e. advance) and its laying arm will lay a single course of blocks and then when it retracts (i.e. retreats) its laying arm will lay blocks in a plurality of course utilizing the available reach and dexterity of the laying arm. In this manner, laying is able to be optimized to increase the overall laying rate and efficiency of the robot as it traverses around the building site. When sequencing blocks for a multiple course retreat, machine constraints such as laying envelope of the laying arm are input to ensure that the machine is capable of laying blocks in the specified sequence. The physical envelope of the machine is also considered in determining a particular sequence to ensure that the machine will not physically clash with any previously laid blocks.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers. As used herein and unless otherwise stated, the term “approximately” means±20%.

Persons skilled in the art will appreciate that numerous variations and modifications will become apparent. All such variations and modifications which become apparent to persons skilled in the art, should be considered to fall within the spirit and scope that the invention broadly appearing before described.

The claims defining the invention are as follows:

1. A method for use in construction of a building, the method including:
laying a plurality of courses of blocks onto a foundation to define:
walls of a first storey of the building; and,
a plurality of hollow formwork columns;
inserting reinforcing structure into the hollow formwork columns; and
pouring concrete into the hollow formwork columns around the reinforcing structure so as to form concrete columns for supporting a slab of a second storey, wherein the blocks forming the plurality of hollow formwork columns remain part of the building structure as permanent formwork.

2. The method according to claim 1, wherein for each hollow formwork column, at least one block in a first course thereof is left out of the column to provide an opening to allow access at a base of the column for securing the reinforcing structure.

3. The method according to claim 2, wherein the reinforcing structure is one of:
coupled to starter bars protruding from the foundation; and,
anchored into holes drilled into the foundation and adhesively bonded therein.

4. The method according to any one of the preceding claims, wherein for each hollow formwork column, any open perp gaps are sealed prior to pouring the concrete.

5. The method according to any one of the preceding claims, wherein for each hollow formwork column, the opening at the base of the column is closed prior to pouring of the concrete.

6. The method according to any one of the preceding claims, wherein at least some of the walls of at least the first storey of the building are reinforced.

7. The method according to claim 6, wherein reinforcing a wall of the building includes the steps:
laying a first plurality of block courses onto the foundation or slab, at least the first block course placed over starter bars that protrude from the foundation;
inserting a first section of reinforcing structure through aligned cavities of the first plurality of courses and coupling a base of the first section of reinforcing structure to the starter bars; and,
pouring concrete into the aligned cavities of the first plurality of courses.

8. The method according to claim 7, wherein reinforcing a wall of the building further includes the steps:
laying a second plurality of courses on top of the first plurality of courses;
inserting a second section of reinforcing structure through aligned cavities of the second plurality of courses and coupling a base of the second section of reinforcing structure to the top of the first section of reinforcing structure; and,
pouring concrete into the aligned cavities of the second plurality of courses.

9. The method according to claim 8, wherein further sections of reinforcing structure are coupled together as a height of the wall increases.

10. The method according to claim 9, wherein each section of reinforcing structure is approximately as long as a height of three courses of blocks.

11. The method according to claim 10, wherein the second storey slab is precast and positioned onto the first storey using a crane.

12. The method according to any one of the preceding claims, wherein the building is constructed using a robotic block laying machine that lays blocks in accordance with a block sequence defined by a machine datafile that permits blocks of either the first or second storey to be placed in either a course by course or multiple course sequence.

13. The method according to claim 12, further including laying a plurality of courses of blocks onto the second storey slab to define walls of the second storey of the building, wherein multiple courses are constructed simultaneously in accordance with the block sequence specified by the machine datafile.

14. The method according to claim 13, wherein a tracking system is used to determine at least the position and optionally orientation of an end effector of the robotic block laying machine, the tracking system requiring line of sight between one or more tracking instruments and one or more tracking targets and wherein the block sequence for the walls of the second storey is determined at least in part using line of sight constraints associated with each block.

15. The method according to claim 14, wherein the one or more tracking instruments are positioned adjacent the foundation and the one or more tracking targets are disposed on the machine proximate the end effector and wherein the one or more tracking instruments are positioned higher than the second storey slab.

16. The method according to claim 14 or claim 15, wherein the block sequence is determined in at least one electronic processing device by:
obtaining build data indicative of block position and size;
determining dependency rules associated with each block in the build that define a specific ordering dependency for the blocks such that the line of sight constraints are satisfied; and,
generating the block sequence based at least in part on the dependency rules.

17. The method according to claim 16, wherein for each block, the method includes in the at least one electronic processing device:
determining a subgroup of blocks that have line of sight occluded by a current block; and,
assigning a dependency to the subgroup of blocks specifying that they must each be placed prior to the current block.

18. The method according to claim 17, wherein determining the subgroup of blocks includes:
determining a first subgroup of candidate blocks that may be occluded in the X axis plane of the tracking instrument;
determining a second subgroup of candidate blocks that may be occluded in the Y axis plane of the tracking instrument;
optionally determining a third subgroup of candidate blocks that may be occluded in the Z axis plane of the tracking instrument; and,
selecting blocks common to the first, second and optionally third subgroup.

19. The method according to claim 17 or claim 18, wherein the block sequence is generated by one of:
processing all of the blocks in the build in one batch; and,
processing groups of blocks iteratively in multiple batches based on number of block dependencies.

20. The method according to claim 19, wherein for multiple batch processing, each group of processed blocks has assigned zero, one or two dependencies.

21. The method according to claim 20, wherein after each batch has been processed, block dependencies of remaining blocks are updated.

22. The method according to any one of claims 14 to 21, wherein segments of walls further away from the tracking instrument and/or robotic block laying machine are constructed at least partially in advance of segments of walls closest to the tracking instrument.

23. The method according to claim 22, wherein the structure is built up from a distal portion towards a proximal portion relative to the tracking instrument and/or robotic block laying machine.

24. A method of constructing a building at a site using a robotic block laying machine, the method including constructing walls with the machine by placing blocks in a plurality of courses according to a build strategy, wherein the build strategy includes constructing multiple courses simultaneously or constructing wall substructures sequentially in accordance with a block sequence based at least in part on build constraints associated with at least one of: the site, a building plan, the robotic block laying machine and a tracking instrument used in monitoring a position of the machine and controlling its movement around the site.

25. The method according to claim 24, wherein multiple courses are constructed as an arm of the robotic blocklaying machine retreats back from an extended position towards the machine.

26. The method according to claim 25, wherein a single course is constructed as the arm of the robotic blocklaying machine advances or extends away from the machine.

27. The method according to any one of claims 24 to 26, wherein segments of walls further away from the tracking instrument and/or robotic block laying machine are constructed at least partially in advance of segments of walls closest to the tracking instrument.

28. The method according to claim 27, wherein the structure is built up from a distal portion towards a proximal portion relative to the tracking instrument and/or robotic block laying machine.

29. The method according to claim 27 or claim 28, wherein the building is constructed using a substructure retreat, whereby the building plan considers the build as multiple wall substructures which are completed sequentially starting from a substructure furthest away from the machine.
